(19) United States
(12) Patent Application Publication
(10) Pub. No.: US 2020/0055394 A1
(43) Pub. Date: Feb. 20, 2020

(54) SYSTEM FOR DETECTING ABNORMAL BEHAVIORS OF A DRIVER

(71) Applicant: Tse-Hsing Chen, Taipei City (TW)

(72) Inventor: Tse-Hsing Chen, Taipei City (TW)

(21) Appl. No.: 16/449,721

(22) Filed: Jun. 24, 2019

(30) Foreign Application Priority Data
Aug. 17, 2018 (TW) 107211333

(51) Int. Cl. B60K 28/06; G07C 9/00; B60R 25/23; E05B 81/54

(52) U.S. Cl. CPC B60K 28/063; E05B 81/54; B60R 25/23; G07C 9/00896

(57) ABSTRACT

A system for detecting abnormal behaviors of a driver of a vehicle includes: an input unit including a display module for displaying a plurality of buttons with different colors and characters to allow the driver to select desired buttons to generate an input password; a processing unit connected with the input unit and including: a random control module for randomly re-arranging the colors and the characters every time after the driver has entered one of the buttons; and a password verification module for comparing the input password and a predetermined password and generating an unlock instruction when the input password matches the predetermined password; a communication unit connected with the processing unit for receiving and transmitting the unlock instruction; and an unlock control unit connected with the communication unit for unlocking a door lock or an engine lock of the vehicle upon receiving the unlock instruction.

### BACKGROUND

### 1. Technical Field

The present disclosure relates to systems for detecting abnormal behaviors of a driver, and, more particularly, to a system for testing the reaction time of a driver to prevent drunk or drugged driving.

### 2. Description of Related Art

According to the data released by the World Health Organization, about 1.3 million people worldwide die from traffic accidents each year. Among them, drunk driving is a major cause of traffic accidents. Therefore, drunk driving has always been a key project of traffic safety prevention.

It is well known that when alcohol enters the bloodstream, it acts on the cerebral cortex as a central nervous system inhibitor, affecting brain function and slowing down response time and reduces cognitive function. Typically, when the alcohol concentration in the bloodstream exceeds 0.01%, a person may experience the feeling of drowsiness, slowed reaction time, and sharp decreases in both concentration and cognitive function, affecting their judgments and visual abilities. When alcohol affects the cerebellum, it makes people feel clumsy, sluggish, less likely to remember things, or even lethargic. If a person in these conditions chooses to drive or ride a vehicle, it can be dangerous. When the blood alcohol concentration exceeds 0.03%, it may impair a person's vision to the extent that he or she can only see part of the surrounding environment. In some cases, people may experience a so-called “moth effect”—people with declined cognitive function may subconsciously move towards bright places, sometimes crossing to the opposite lanes on the roads and resulting in road accidents.

Although there are alcohol detectors on the market, most of the existing alcohol detectors for detecting excessive alcohol are alcohol breath testers that are repetitively shared among different people. This may result in a driver rejecting the use of it due to health concerns. There is also the need to replace the mouthpiece of the tester after each use. Not only the cost of the equipment associated with the detector is already high, but the cost is further increased owing to the replacement of the mouthpiece. For these reasons, this type of alcohol is typically only used among law enforcement and the general public is not compelled to purchase such an item. Even if the alcohol detectors are given to drivers free of charge, they may still reject the detectors due to complicated installations.

Furthermore, in recent years, serious traffic accidents caused by driving after drug abuse have also become more common. Drug reactions may include impaired central nervous system, changes in consciousness, inability to concentrate, uncoordinated movement, lowered ability to make judgments, deviation of behavioral patterns, longer reaction time, blurred vision, and even delusion and lethargy. When a drug takes effect in a person, it is difficult or almost impossible for the person to drive a car or ride a motorcycle safely. Accident rate under the influence of drugs is usually higher than that caused by drunk driving, which seriously affects driving safety and public order.

Because there are numerous types of drugs, screening tests for different drugs are also different. Moreover, these screening tests take time and the results cannot be obtained immediately, so almost no vehicles are equipped with instruments for drug screening. People who are under the influence of drugs often go undetected in the standard screening tests for alcohol.

Some common drugs have been found to affect driving ability, including: 1) Chinese medicine preparations with alcohol as adjuvant, such as medicinal liquor; 2) antihistamine drugs for treating runny nose and allergies; 3) sleeping pills; 4) anticholinergic competent drugs, such as antidepressants, drugs for the treatment of overactive bladder; and 5) LSD or drugs that produce hallucinogenic effects. As can be seen, even legal drugs, such as sleeping pill, cold medicine or anti-allergic drugs, may still cause poor concentration, mental paralysis, hallucination, slow response, poor judgment, etc. in people. Driving under the influence of these legal/illicit drugs may be life-threatening.

In addition, access to cars have become more convenient these days in that a driver only needs to press a button on a remote control to unlock the door lock and another button to unlock the engine lock before starting to drive. Some vehicles are even equipped with, for example, passive keyless entry (PKE). As long as a driver is carrying a remote control with him, he only needs to place his hand on the door handle to unlock the door and presses a start engine button in the vehicle before driving the vehicle away. These actions are easy to perform and can be carried out rather effortlessly even under the influence of alcohol or drugs. With this easy access to vehicles, the likelihood of road accidents increases. Therefore, there is a need in the industry for a means for detecting abnormal behaviors of a driver possibly under the influence of alcohol or drugs or a vehicle thief to ensure the safety of both the vehicle and the driver.

### SUMMARY

In view of the aforementioned shortcomings of the prior art, the present disclosure provides a system for detecting abnormal behaviors of a driver of a vehicle that is capable of preventing drunk or drugged driving as well as vehicle theft. The system may include: an input unit, which may include: a display module for displaying a plurality of buttons with different colors and characters to allow the driver to select desired buttons for generating an input password; a processing unit connected with the input unit, which may include: a random control module for randomly re-arranging the colors and the characters on the buttons every time after the driver has entered one of the buttons; and a password verification module for comparing the input password and a predetermined password and generating an unlock instruction when the input password matches the predetermined password; a communication unit connected with the processing unit for receiving and transmitting the unlock instruction; and an unlock control unit connected with the communication unit for unlocking a door lock or an engine lock of the vehicle upon receiving the unlock instruction.

In an embodiment, the processing unit may further include a timing module for determining an input time the driver has taken to generate the input password.

In an embodiment, the driver inputs the correct password multiple times (e.g., five to six times) in advance, so that an average input time for inputting a correct password is obtained through machine learning. If one of the multiple input times for inputting a correct password is substantially and significantly greater than the rest of the input times, then the processing unit excludes this input time from calculation of the average of the multiple input times.

In an embodiment, the processing unit compares the input time determined by the timing module and a predetermined input time, and if the input time is greater than the predetermined input time, the processing unit generates a re-enter password instruction and transmits it to the input unit.

In an embodiment, the predetermined input time is 1.1 to 1.5 times of an average of multiple input times for inputting a correct password.

In an embodiment, a maximum allowable time for entering a correct password is set. If the predetermined input time derived from the average time learnt through machine learning exceeds the maximum allowable time for entering a correct password, the maximum allowable time for entering a correct password is used as the predetermined input time.

In an embodiment, when the password verification module consecutively determines a mismatch between the input password and the predetermined password a predetermined number of times, the processing unit stops accepting the input password from the input unit and waits for a predetermined waiting period before accepting the input password again.

In an embodiment, the colors of the buttons may be visually similar to the colors of the characters on the buttons, such that they become more difficult to be identified by people under the influence of alcohol or drugs, but still identifiable by people under normal circumstances.

In an embodiment, the predetermined password includes alphabet letters or numbers arranged or not arranged in an order to increase the difficulty in cracking the password.

In an embodiment, the communication unit is connected with the unlock control unit via a wireless or wired communication interface.

In an embodiment, the input unit, the processing unit and/or the communication unit is provided in a mobile device or a vehicle-equipped control interface.

In order to save cost, eliminate troubles with installation and use, and increase the wiliness to install, the present disclosure is provided for the purpose of anti-theft in normal conditions. When drug or alcohol is involved, the present disclosure can be used in lieu of the current alcohol and drug testing methods to save cost and to determine whether a person is fit for driving a vehicle based on his/her cognitive ability. In other words, the present disclosure can be used as an vehicle anti-theft system in normal circumstances, and as a system for detecting abnormal behaviors of a driver under the influence of alcohol or drugs based on his/her ability to make judgments and his/her reaction time and preventing the person from driving if he/she is deemed unfit to do so.

### BRIEF DESCRIPTION OF THE DRAWINGS

FIG. 1 is schematic diagram illustrating a system of the present disclosure; and

FIGS. 2 and 3 are schematic diagrams illustrating the system in use in accordance with different embodiments of the present disclosure.

### DETAILED DESCRIPTION OF THE EMBODIMENTS

One of ordinary skill in the art can readily understand the advantages and effects of the present disclosure upon referring to the detailed explanations and embodiments of the present disclosure. These descriptions and embodiments are for illustrative purpose only and in no way limit the present disclosure only to those provided herein.

It should be noted that the structures, ratios, sizes shown in the drawings appended to this specification are to be construed in conjunction with the disclosure of this specification in order to facilitate understanding of those skilled in the art. They are, by no means, meant to limit the present disclosure to the specific details described herein. Without affecting the effects created and objectives achieved by the present disclosure, any modifications, changes or adjustments to the structures, ratio relationships or sizes, are to be construed as fall within the ranges covered by the technical content disclosed herein. Meanwhile, terms, such as “external”, “internal”, “inside”, “outside”, and the like, are for illustrative purposes only, and are not meant to limit the ranges implementable by the present disclosure. Any changes or adjustments made to their relative relationships, without modifying the substantial technical content, are also to be construed as within the ranges implementable by the present disclosure.

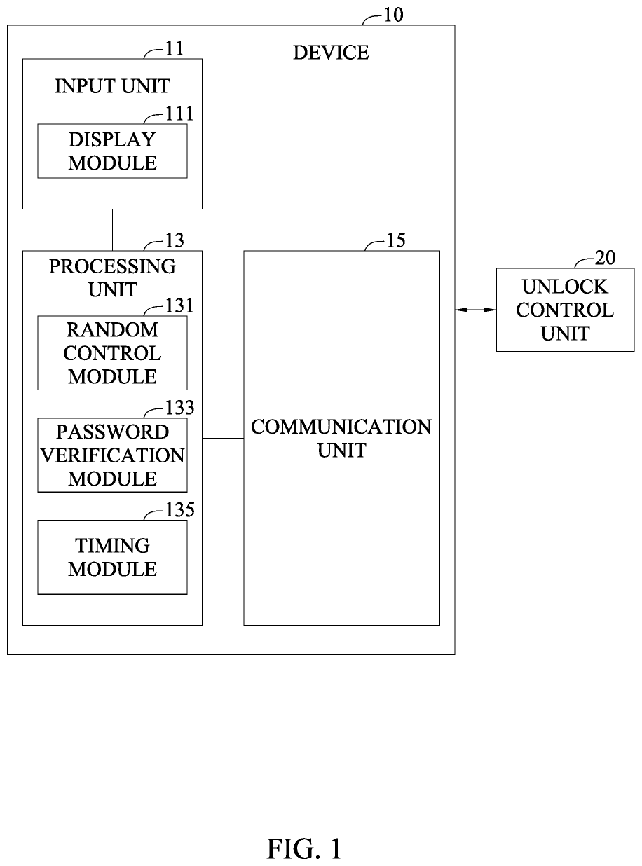

As shown in FIGS. 1 to 3, a system for detecting abnormal behaviors of a driver to prevent both drunk or drugged driving and vehicle theft in accordance with the present disclosure is provided. The system includes an input unit 11, a processing unit 13, a communication unit 15 and an unlock control unit 20. In an embodiment, the input unit 11, the processing unit 13 and the communication unit 15 are provided in the same device 10. The device 10 can be a control interface of a vehicle-equipped device or a mobile device. The input unit 11, the processing unit 13 and the communication unit 15 can be implemented through software, firmware or hardware.

In an embodiment, the input unit 11 can be an apparatus with a touch-sensitive function, and includes a display module 111. The display module 111 displays a plurality of buttons with various colors and characters. The display module 111 provides the buttons or the characters displayed thereon so as to be selected by a driver for entering a password. The colors of these buttons are designed such that they may be more difficult to be identified for people who are under the influence of alcohol or drugs. A password can be alphabet letters and/or numbers arranged or not arranged in an order to increase the difficulty of cracking the password.

The processing unit 13 is connected to the input unit 11, and includes a random control module 131, a password verification module 133 and a timing module 135. The random control module 131 is configured such that, after a driver has entered a button or character, the colors and the characters on the buttons are randomly re-arranged. In other words, the random control module 131 randomly re-arranges the colors and characters on the buttons each time the driver has entered a specific button. This prevents the driver from entering the password out of habit and increases the difficulty in entering the password correctly by a thief or a drunk or drugged driver.

This also avoids onlookers gaining the password by memorizing the locations of the password. The password verification module 133 is used for verifying whether the password entered is correct. If the password entered is correct, an unlock instruction is transmitted to the unlock control unit 20. In an embodiment, the device 10 may store a predetermined password (set by driver or default). When the inputted password matches the predetermined password, the password verification module 133 transmits the unlock instruction to the unlock control unit 20. Otherwise, unlocking is not performed. The timing module 135 is used for timing how long it takes the driver to enter the password. When the input time determined by the timing module 135 exceeds a predetermined input time, the processing unit 13 determines that the reaction time of the driver is too long, and consequently requires the driver to re-enter the password. Accordingly, the password verification module 133 will not generate an unlock instruction. As a result, the vehicle cannot be started. If the predetermined input time is set too short, the reaction time may be too stringent even for people with normal cognitive ability to enter passwords in time. On the contrary, if the predetermined input time is set too long, there is no effective prevention against unauthorized or undesirable unlocking of the vehicle. A preferred embodiment of the processing unit of the present disclosure uses machine learning to obtain an average of multiple input times for entering a correct password and set the predetermined input time to be 1.1 to 1.5 times of the average input time, i.e., 110% to 150% of the average input time for entering the correct password. The average input time can be obtained from five or six occurrences of correct entering of the password. However, if an input time for entering the correct input is much longer than the rest of the input times, this outlier is excluded from the calculation of the average input time. The processing unit 13 may also have a default maximum allowable input time for entering the correct password. If a predetermined input time derived from the machine-learnt average input time exceeds the maximum allowable input time for entering the correct password, the maximum allowable input time for entering the correct password is used as the predetermined input time for entering a password.

If the password verification module 133 determines that wrong passwords have been inputted a predetermined number of times, the processing unit 13 stops accepting any inputted passwords from the input unit 11 and waits for a predetermined waiting period before accepting passwords inputted via the input unit 11. In a preferred embodiment of the present disclosure, the maximum allowed attempts are set to be three. If three unsuccessful consecutive attempts have been made in the predetermined time period, a waiting time of fifteen minutes is imposed before one is allowed to enter the password again. This prevents the driver/thieves from repetitively trying many passwords.

The communication unit 15 is connected to the processing unit 13 for transmitting the unlock instruction from the password verification module 133 to the unlock control unit 20.

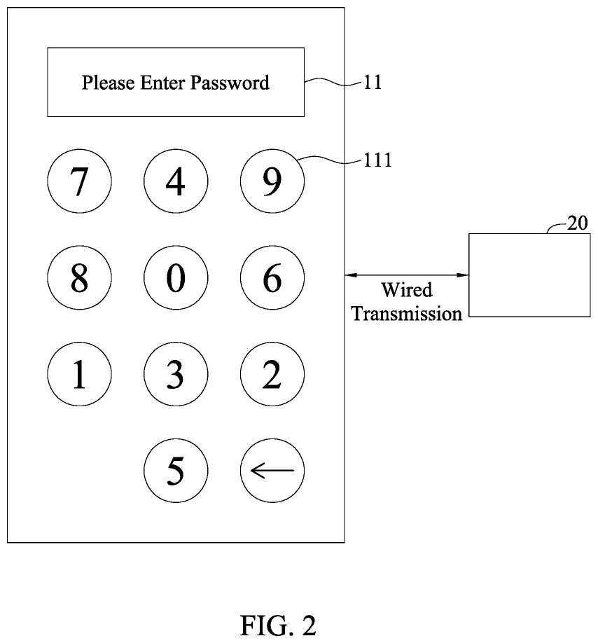

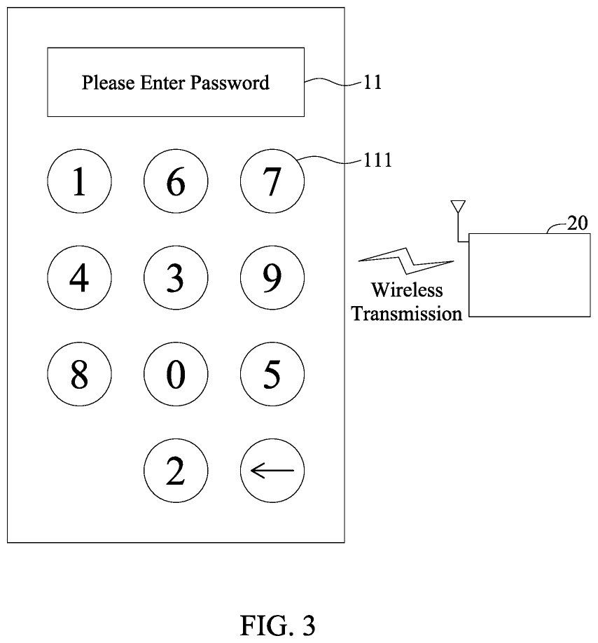

The unlock control unit 20 is provided on a vehicle, and can be, for example, an unlock device for the door, the engine or the steering wheel. The unlock control unit 20 is connected with the communication unit 15 for receiving the unlock instruction of the password verification module 133 in order to unlock the door or the engine to start the vehicle. The connection between the communication unit 15 and the unlock control unit 20 can be implemented via a wireless communication interface using a wireless communication protocol, such as Wi-Fi, Li-Fi, Bluetooth, Wireless USB, NFC, RFID, TransferJet, DSRC, EnOcean, ZigBee or UWB, or a wired interface, such as an open wire line, a RJ-45 copper twisted pair, a LAN wire, a RS232 cable, a twisted pair, coaxial cable, an optical fiber, an universal serial bus (USB), a waveguide or the like. In use, as shown in FIGS. 2 and 3, the driver presses a button or a character displayed on the display module 111 of the input unit 11. Every time a character is pressed, the random control module 131 will then re-arrange the colors of the buttons and the characters on the buttons to increase the difficulty of entering the password correctly, preventing a drunk or drugged person from entering the password relying on habit. In an embodiment, the colors of the buttons, the characters on the buttons and the background are designed to be similar to each other. In another embodiment, the numbers are a light or white color, and the background also uses a light color. In yet another embodiment, the numbers are a dark color, and the background also uses a dark color. Each time a specific button or character is selected, the buttons and characters will change their colors or order, so it takes more effort for the driver to identify the characters. In an embodiment, the driver is required to input the correct password within the predetermined input time, otherwise he will need to enter the password again. If the driver entered the wrong passwords three consecutive times, he will need to wait for the waiting period to elapse before he can re-enter the password to prevent repetitive attempts and brute-force attacks.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A system for detecting abnormal behaviors of a driver of a vehicle, comprising:
an input unit including a display module for displaying a plurality of buttons with different colors and characters to allow the driver to select desired buttons to generate an input password;
a processing unit connected with the input unit and comprising:
a random control module for randomly re-arranging the colors and the characters on the buttons every time after the driver has entered one of the buttons; and
a password verification module for comparing the input password and a predetermined password and generating an unlock instruction when the input password matches the predetermined password;
a communication unit connected with the processing unit for receiving and transmitting the unlock instruction; and
an unlock control unit connected with the communication unit for unlocking a door lock or an engine lock of the vehicle upon receiving the unlock instruction.

2. The system of claim 1, wherein the processing unit further includes a timing module for determining an input time the driver has taken to generate the input password.

3. The system of claim 2, wherein the processing unit compares the input time determined by the timing module and a predetermined input time.

4. The system of claim 3, wherein the input time is greater than the predetermined input time, and the processing unit generates and transmits an instruction for re-entering a password to the input unit.

5. The system of claim 4, wherein the predetermined input time is 1.1 to 1.5 times of an average of multiple input times for inputting a correct password, and the predetermined input time does not exceed a maximum allowable time for entering a correct password.

6. The system of claim 5, wherein one input time among the multiple input times for inputting the correct password is substantially greater than the rest of the input times, the input time is excluded from calculation of the average of the multiple input times.

7. The system of claim 2, wherein the password verification module consecutively determines a mismatch between the input password and the predetermined password a predetermined number of times, and the processing unit stops accepting the input password from the input unit and waits for a predetermined waiting period before accepting the input password again.

8. The system of claim 1, wherein the colors of the buttons are visually similar to the colors of the characters on the buttons.

9. The system of claim 1, wherein the predetermined password includes alphabet letters or numbers arranged in an order.

10. The system of claim 1, wherein the communication unit is connected with the unlock control unit via a wireless communication interface.

11. The system of claim 1, wherein at least one of the input unit, the processing unit, and the communication unit is provided in a mobile device or a vehicle-equipped control interface.

12. The system of claim 1, wherein the predetermined password includes alphabet letters or numbers not arranged in an order.

13. The system of claim 1, wherein the communication unit is connected with the unlock control unit via a wired communication interface.
